(19) United States
(12) Patent Application Publication
(10) Pub. No.: US 2023/0074568 A1
(43) Pub. Date: Mar. 9, 2023

(54) HARVESTING METHOD

(71) Applicant: Panasonic Intellectual Property Management Co., Ltd., Osaka (JP)

(72) Inventor: KEIICHIRO SHIMOMURA, Hyogo (JP)

(21) Appl. No.: 17/822,630

(22) Filed: Aug. 26, 2022

(30) Foreign Application Priority Data
Sep. 7, 2021 (JP) 2021-145361

(51) Int. Cl. A01D 46/24

(52) U.S. Cl. CPC A01D 46/24

(57) ABSTRACT

A harvesting method is performed by a harvesting device. The harvesting device includes an upper harvest ring having an upper through hole through which a fruit can be passed, and a lower harvest ring disposed below the upper harvest ring and having a lower through hole through which the fruit can be passed. The harvesting method includes moving, by the harvesting device, the upper harvest ring and the lower harvest ring along a surface shape of the fruit to position a fruit stalk of the fruit or the fruit inside each of the upper through hole and the lower through hole, and moving, by the harvesting device, the upper harvest ring relative to the lower harvest ring to harvest the fruit.

### BACKGROUND

### 1. Technical Field

The present disclosure relates to a harvesting method.

### 2. Description of the Related Art

In the related art, as a device for automatically harvesting fruits, for example, a harvesting device described in Japanese Patent Application Laid-Open No. 63-141517 (Patent Literature 1) is known. The harvesting device in Patent Literature 1 includes a vacuum pad that suctions fruits and a motor that rotates and vibrates the vacuum pad. The harvesting device suctions fruits with the vacuum pad, and rotates and vibrates the vacuum pad to separate, from branches, ripe fruits on the branches.

### CITATIONS LIST

### Patent Literature

PTL 1: Unexamined Japanese Patent Publication S63-141517

### SUMMARY

A harvesting method according to an aspect of the present disclosure is a harvesting method performed by a harvesting device. The harvesting device includes an upper harvest ring having an upper through hole through which a fruit can be passed, and a lower harvest ring disposed below the upper harvest ring and having a lower through hole through which the fruit can be passed. The harvesting method includes moving, by the harvesting device, the upper harvest ring and the lower harvest ring along a surface shape of the fruit to position a fruit stalk of the fruit or the fruit inside each of the upper through hole and the lower through hole, and moving, by the harvesting device, the upper harvest ring relative to the lower harvest ring to harvest the fruit.

### BRIEF DESCRIPTION OF THE DRAWINGS

FIG. 1 is a schematic view showing a form of fruits according to first and second embodiments;

FIG. 2 is a schematic view of a harvesting device according to the first and second embodiments;

FIG. 3 is a perspective view showing an internal structure of a harvest mechanism constituting an end effector of the harvesting device according to the first and second embodiments;

FIG. 4A is a perspective view of an upper harvest ring and an upper ring drive unit constituting the harvest mechanism according to the first and second embodiments;

FIG. 4B is a perspective view of a lower harvest ring and a lower ring drive unit constituting the harvest mechanism according to the first and second embodiments;

FIG. 5 is a perspective view showing a part of a harvest control mechanism constituting the end effector according to the first embodiment;

FIG. 6A is a schematic side view of the harvest control mechanism according to the first embodiment;

FIG. 6B is a schematic front view of the harvest control mechanism according to the first embodiment;

FIG. 7 is an explanatory diagram of a harvesting method for a harvesting target fruit according to the first embodiment;

FIG. 8 is a schematic view showing an example of a range in which the harvesting device according to the first and second embodiments can harvest the harvesting target fruit;

FIG. 9A is a schematic view showing a state in which a ring distal end portion according to the first embodiment is positioned at a start point;

FIG. 9B is a schematic view showing a state in which the ring distal end portion according to the first embodiment is positioned at a lowest point;

FIG. 9C is a schematic view showing a state in which the ring distal end portion according to the first embodiment is positioned at an end point;

FIG. 10A is a schematic side view of a harvest control mechanism constituting the end effector of the harvesting device according to the second embodiment; and

FIG. 10B is a schematic front view of the harvest control mechanism according to the second embodiment.

### DETAILED DESCRIPTIONS

An object of the present disclosure is to provide a harvesting method capable of preventing a decrease in harvest efficiency of fruits.

### First Embodiment

A first embodiment according to the present disclosure will be described.

<Form of Fruit>

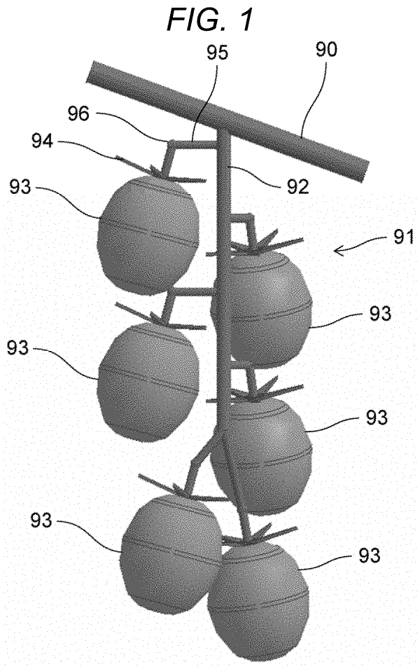

First, a form of a fruit to be harvested in the first embodiment of the present disclosure and in a second embodiment to be described later will be described. In the first and second embodiments, tomatoes are exemplified as the fruit, and other fruits such as strawberry, blueberry, and raspberry may also be used for exemplifications. FIG. 1 is a schematic view showing a form of the fruit.

As shown in FIG. 1, tuft 91 branched from main stem 90, which is an example of a branch, hangs down due to its own weight or the like. Tuft 91 has fruit stem 92. A plurality of fruits 93 grow around fruit stem 92. Fruit 93 has calyx 94. Calyx 94 is connected to fruit stem 92 via small fruit stem 95, which is an example of a fruit stalk. Release layer 96 is a special cell layer formed between main stem 90 and an axis of fruit 93. Release layer 96 is a portion that is positioned in the middle of small fruit stem 95 and can be relatively easily separated by a pulling force or the like.

<Configuration of Harvesting Device>

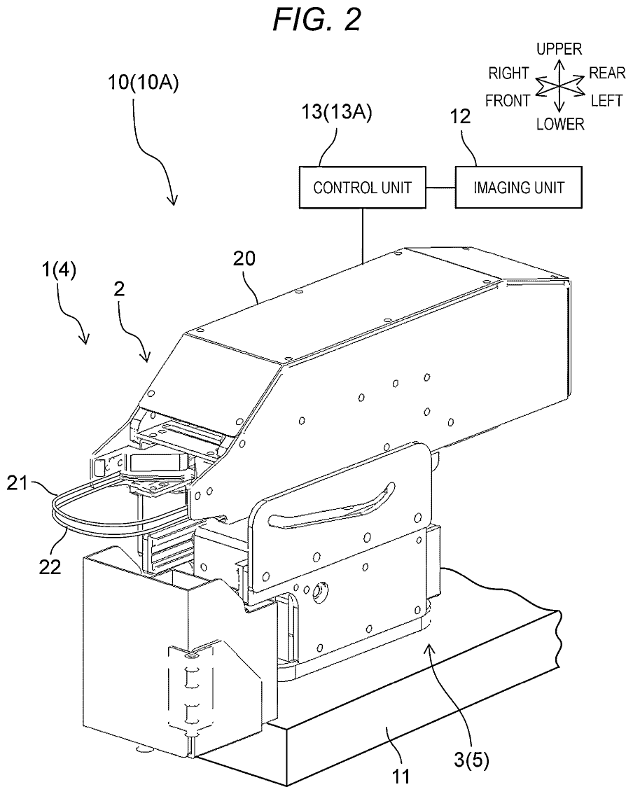

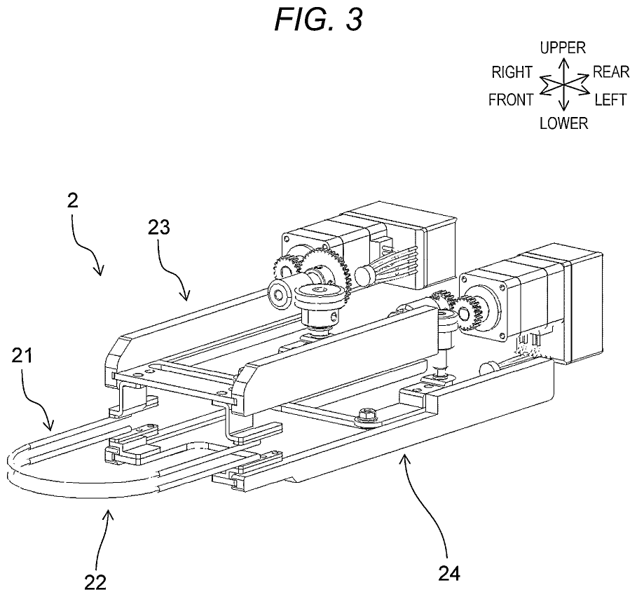

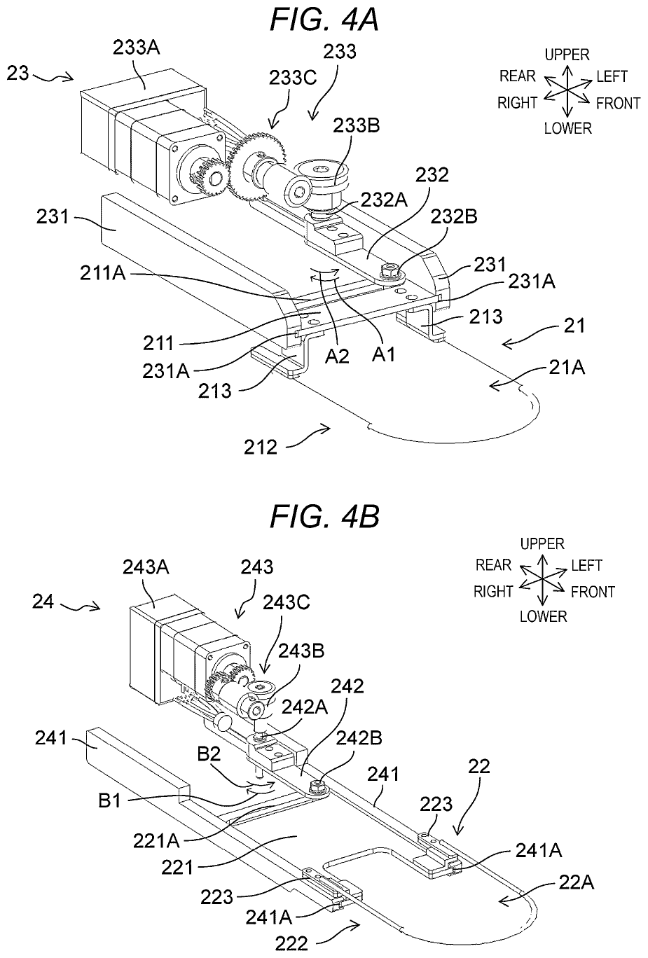

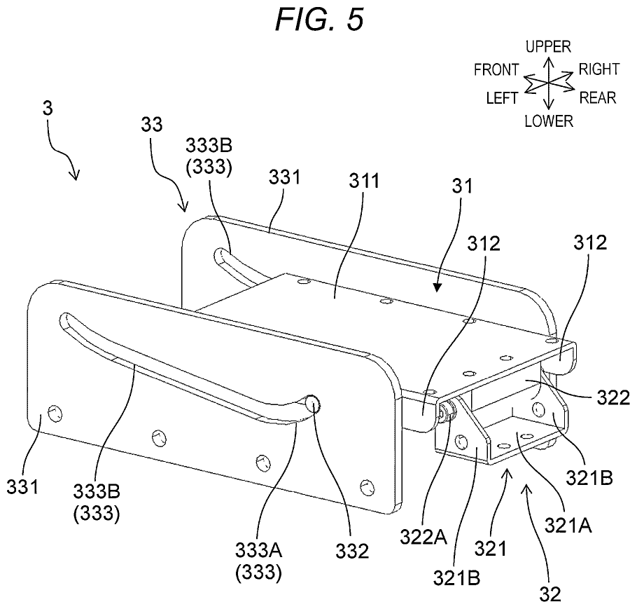

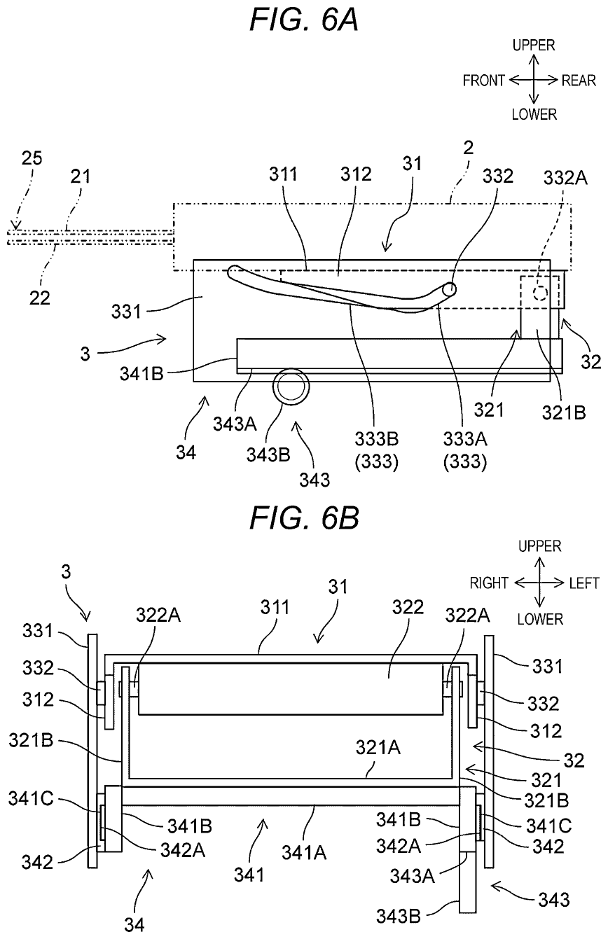

Next, a configuration of a harvesting device will be described. FIG. 2 is a schematic view of the harvesting device. FIG. 3 is a perspective view showing an internal structure of a harvest mechanism constituting an end effector of the harvesting device. FIG. 4A is a perspective view of an upper harvest ring and an upper ring drive unit constituting the harvest mechanism. FIG. 4B is a perspective view of a lower harvest ring and a lower ring drive unit constituting the harvest mechanism. FIG. 5 is a perspective view showing a part of a harvest control mechanism constituting the end effector. FIG. 6A is a schematic side view of the harvest control mechanism. FIG. 6B is a schematic front view of the harvest control mechanism. A front side is a side on which a fruit is positioned with respect to the end effector when the end effector harvests the fruit. A rear side is a side opposite to the front side. A right side is a right side when the end effector is viewed from the rear side. A left side is a side opposite to the right side. An upper side is an upper side when the harvesting device is installed on a horizontal plane. A lower side is a side opposite to the upper side.

Harvesting device 10 shown in FIG. 2 includes end effector 1, work arm 11, imaging unit 12, and control unit 13. Work arm 11 holds end effector 1. Control unit 13 controls work arm 11 and end effector 1 based on an imaging result of imaging unit 12. End effector 1 moves to a vicinity of fruit 93 by driving of work arm 11 based on control of control unit 13, and then performs a harvest operation of fruit 93. End effector 1 includes harvest mechanism 2 and harvest control mechanism 3.

Harvest mechanism 2 is covered with cover 20. Harvest mechanism 2 includes upper harvest ring 21 and lower harvest ring 22. As will be described in detail later, harvest mechanism 2 moves upper harvest ring 21 and lower harvest ring 22 along a surface shape of fruit 93, thereby positioning small fruit stem 95 or fruit 93 inside each of upper harvest ring 21 and lower harvest ring 22. Then, harvest mechanism 2 harvests fruit 93 by moving upper harvest ring 21 relative to lower harvest ring 22. As shown in FIG. 3, harvest mechanism 2 further includes upper ring drive unit 23 and lower ring drive unit 24. Lower harvest ring 22 and lower ring drive unit 24 are disposed below upper harvest ring 21 and upper ring drive unit 23.

As shown in FIG. 4A, upper harvest ring 21 includes upper slide member 211, upper arc member 212, and coupling members 213. Upper slide member 211 is formed in a rectangular plate shape. Upper slit 211A extending in a left-right direction (long-side direction) is formed in upper slide member 211. Upper arc member 212 includes an arc portion having an arc shape and a pair of linear portions each having a linear shape. The pair of linear portions extend rearward from both ends of the arc portion and are parallel to each other. Coupling members 213 couple portions on both end sides of upper slide member 211 in the left-right direction and rear end portions of the pair of linear portions of upper arc member 212. Upper slide member 211 and upper arc member 212 coupled by coupling members 213 define upper through hole 21A of upper harvest ring 21.

Upper ring drive unit 23 moves upper harvest ring 21 in a front-rear direction in a posture in which an opening of upper through hole 21A faces upward. Upper ring drive unit 23 includes a pair of upper guide members 231, upper rotary arm 232, and upper drive mechanism 233.

The pair of upper guide members 231 face each other. Guide grooves 231A extending in the front-rear direction are formed in surfaces of the pair of upper guide members 231 facing each other. Both end portions of upper slide member 211 of upper harvest ring 21 in the left-right direction (long-side direction) are fitted into the pair of guide grooves 231A. With such a configuration, upper harvest ring 21 is supported by upper guide member 231 so as to be slidable in the front-rear direction.

Upper rotary arm 232 is formed in a substantially rectangular shape in a plan view. Upper rotary shaft 232A is fixed to one end side of upper rotary arm 232 in a longitudinal direction. For example, upper rotary arm 232 rotates about upper rotary shaft 232A disposed in a vicinity of left-side upper guide member 231. Upper insertion shaft 232B is disposed on a rotation distal end side of upper rotary arm 232. Upper insertion shaft 232B is inserted through upper slit 211A of upper harvest ring 21. A cam follower may be used instead of upper insertion shaft 232B.

Upper drive mechanism 233 includes upper ring motor 233A, gear 233B, and power transmission unit 233C. Upper ring motor 233A is driven under the control of control unit 13. Gear 233B is fixed to upper rotary shaft 232A. Power transmission unit 233C includes a gear, a worm gear, and the like, and transmits a driving force of upper ring motor 233A to gear 233B.

In upper ring drive unit 23 having the above configuration, when upper harvest ring 21 is moved in a rearward direction, upper ring motor 233A is driven so that upper rotary arm 232 rotates in a direction of arrow A1. With the rotation of upper rotary arm 232 in the direction of arrow A1, upper insertion shaft 232B moves inside upper slit 211A to move upper harvest ring 21 in the rearward direction. On the other hand, when upper harvest ring 21 is moved in a forward direction, control unit 13 drives upper ring motor 233A so that upper rotary arm 232 rotates in a direction of arrow A2.

As shown in FIG. 4B, lower harvest ring 22 includes lower slide member 221, lower arc member 222, and coupling members 223. Lower slide member 221 is formed in a rectangular plate shape. Lower slit 221A extending in the left-right direction (short-side direction) is formed in lower slide member 221. Lower arc member 222 is formed in the same shape as upper arc member 212, and includes an arc portion and a pair of linear portions each having a linear shape. Coupling members 223 couple portions on both end sides of lower slide member 221 in the left-right direction and rear end portions of the pair of linear portions of lower arc member 222. Lower slide member 221 and lower arc member 222 coupled by coupling members 223 define lower through hole 22A of lower harvest ring 22.

Lower ring drive unit 24 moves lower harvest ring 22 in the front-rear direction in a posture in which an opening of lower through hole 22A faces upward. Lower ring drive unit 24 has the same structure as upper ring drive unit 23. Therefore, differences between lower ring drive unit 24 and upper ring drive unit 23 will be mainly described. Lower ring drive unit 24 includes a pair of lower guide members 241, lower rotary arm 242, and lower drive mechanism 243.

The pair of lower guide members 241 are disposed to face each other. Both end portions of lower slide member 221 of lower harvest ring 22 in the left-right direction are fitted into guide grooves 241A formed in surfaces of the pair of lower guide members 241 facing each other. With such a configuration, lower harvest ring 22 is supported by lower guide member 241 so as to be slidable in the front-rear direction.

Lower rotary shaft 242A is fixed to one end side of lower rotary arm 242 in the longitudinal direction. Lower insertion shaft 242B inserted into lower slit 221A of lower harvest ring 22 is disposed on a rotation distal end side of lower rotary arm 242. A cam follower may be used instead of lower insertion shaft 242B. For example, lower rotary arm 242 is configured to rotate about lower rotary shaft 242A disposed in a vicinity of left-side lower guide member 241.

Lower drive mechanism 243 includes lower ring motor 243A that is driven under the control of control unit 13, gear 243B fixed to lower rotary shaft 242A, and power transmission unit 243C that transmits a driving force of lower ring motor 243A to gear 243B. Power transmission unit 243C includes a gear, a worm gear, and the like.

In lower ring drive unit 24 having the above configuration, when lower harvest ring 22 is moved in the rearward direction, lower ring motor 243A is driven so that lower rotary arm 242 rotates in a direction of arrow B1. On the other hand, when lower harvest ring 22 is moved in the forward direction, control unit 13 drives lower ring motor 243A so that lower rotary arm 242 rotates in a direction of arrow B2.

Harvest control mechanism 3 moves each of harvest rings 21 and 22 so that the distal end portion of each of harvest rings 21 and 22 (upper harvest ring 21 and lower harvest ring 22) moves along the surface shape of fruit 93. Distal end portions of harvest rings 21 and 22 may be collectively referred to as “ring distal end portion 25” (for example, see FIG. 6A). The surface shape of fruit 93 along which ring distal end portion 25 moves means an outline (outer shape) of fruit 93 when fruit 93 is viewed from the right side or the left side. Ring distal end portion 25 is a portion centered in an outer peripheral direction of the arc portion in upper arc member 212 of upper harvest ring 21 and lower arc member 222 of lower harvest ring 22. As shown in FIG. 5, harvest control mechanism 3 includes harvest mechanism support member 31, rotation support portion 32, and rotation control mechanism 33.

Harvest mechanism support member 31 includes support portion 311 having a rectangular plate shape. Harvest mechanism 2 is fixed on support portion 311 (see FIG. 6A). Side wall portions 312 extending downward in a plate shape are formed on both side edges of support portion 311 in the left-right direction (short-side direction). Rotation support portion 32 rotatably supports harvest mechanism support member 31. Rotation support portion 32 includes base member 321 and coupling member 322.

Base member 321 includes fixing portion 321A having a rectangular plate shape. Bearing portions 321B extending upward in a plate shape are formed on both side edges of fixing portion 321A in the left-right direction (long-side direction). Coupling member 322 is formed in a rectangular parallelepiped shape. Rotary shaft portion 322A is fixed to both side surfaces of coupling member 322 in the left-right direction (long-side direction). Rotary shaft portion 322A is supported by bearing portions 321B. A rear portion of support portion 311 of harvest mechanism support member 31 is fixed to an upper surface of coupling member 322.

Rotation control mechanism 33 controls a rotation state of harvest mechanism support member 31. Rotation control mechanism 33 includes a pair of cam plates 331 and a pair of cam followers 332.

The pair of cam plates 331are disposed to face side wall portions 312 of harvest mechanism support member 31, respectively. Cam groove 333 extending in the front-rear direction is formed in each cam plate 331. Cam groove 333 includes lowering groove 333A and lifting groove 333B. Lowering groove 333A is formed such that a rear portion thereof is positioned higher than a front portion thereof. A rear end of lifting groove 333B is connected to a front end of lowering groove 333A. Lifting groove 333B is formed such that a rear portion thereof is positioned lower than a front portion thereof. Lifting groove 333B is formed such that a front portion thereof is positioned higher than a rear portion of lowering groove 333A.

The pair of cam followers 332 are formed in a columnar shape, and are respectively disposed on side wall portions 312 of harvest mechanism support member 31. Each cam follower 332 is inserted into cam groove 333 of corresponding cam plate 331.

As shown in FIGS. 6A and 6B, harvest control mechanism 3 further includes advancing and retreating movement control mechanism 34. Advancing and retreating movement control mechanism 34 moves harvest mechanism support member 31 in the front-rear direction with respect to cam plate 331. Advancing and retreating movement control mechanism 34 includes movable member 341, a pair of guide members 342, and advancing and retreating drive unit 343.

Movable member 341 includes movable base 341A having a rectangular plate shape. Side wall portions 341B extending downward in a plate shape are formed on both side edges of movable base 341A in the left-right direction (short-side direction). Fixing portion 321A of base member 321 is fixed to an upper surface on a rear end side of movable base 341A. Rail portion 341C extending in the front-rear direction is formed on each of a right surface of right-side wall portion 341B and a left surface of left-side wall portion 341B.

The pair of guide members 342 are respectively disposed on surfaces of the pair of cam plates 331 facing each other. Rail portions 341C of movable member 341 are fitted into guide grooves 342A formed on surfaces of the pair of guide members 342 facing each other. With such a configuration, movable member 341 is supported by guide members 342 so as to be slidable in the front-rear direction.

Advancing and retreating drive unit 343 includes an advancing and retreating motor (not shown), rack 343A, pinion 343B, and a power transmission unit (not shown). The advancing and retreating motor is driven under the control of control unit 13. Rack 343A is formed at a lower end edge of left-side wall portion 341B of movable member 341. Pinion 343B is disposed below left-side wall portion 341B so as to mesh with rack 343A.

The power transmission unit includes a gear, a worm gear, and the like, and transmits a driving force of the advancing and retreating motor to pinion 343B.

<Operation of Harvesting Device>

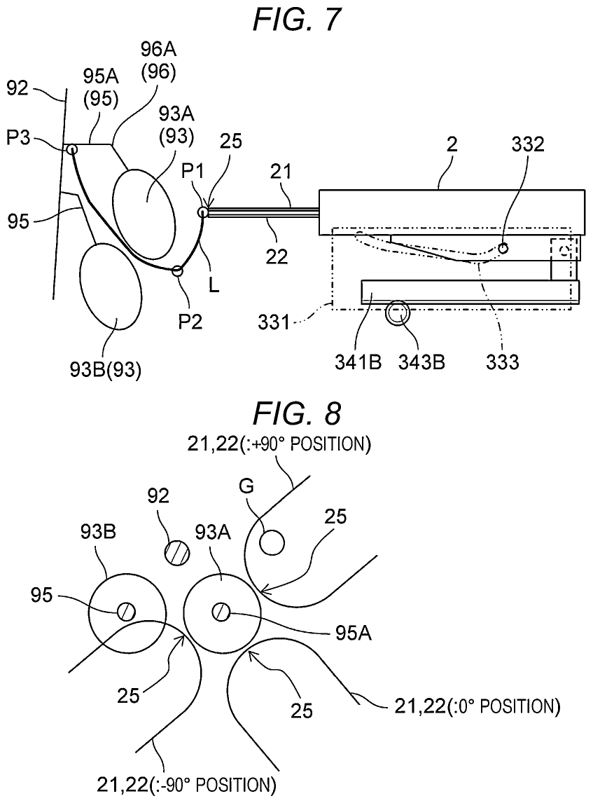

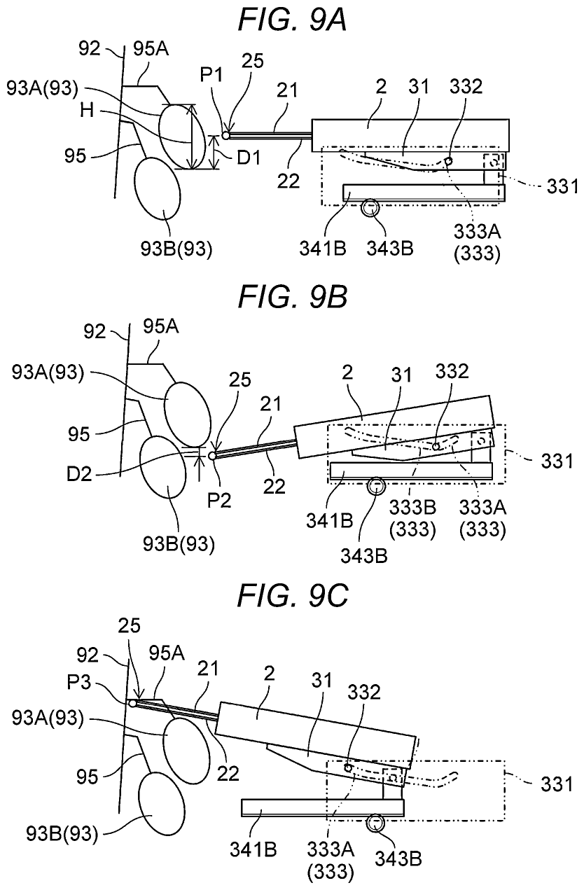

Next, as an operation of harvesting device 10, a harvesting method for fruit 93 to be harvested will be described. Hereinafter, fruit 93 to be harvested may be referred to as “harvesting target fruit 93A”, and fruit 93 not to be harvested may be referred to as “non-harvesting target fruit 93B”. FIG. 7 is an explanatory diagram of a harvesting method for a harvesting target fruit. FIG. 8 is a schematic view showing an example of a range in which the harvesting device can harvest the harvesting target fruit. FIG. 9A is a schematic view showing a state in which a ring distal end portion is positioned at a start point. FIG. 9B is a schematic view showing a state in which the ring distal end portion is positioned at a lowest point. FIG. 9C is a schematic view showing a state in which the ring distal end portion is positioned at an end point.

First, an outline of the harvesting method will be described. As shown in FIG. 7, harvesting device 10 moves upper harvest rings 21 and 22 such that ring distal end portion 25 of end effector 1 draws trajectory L including start point P1, lowest point P2, and end point P3, thereby inserting small fruit stem 95A of harvesting target fruit 93A into through holes 21A and 22A (upper through hole 21A and lower through hole 22A). That is, harvesting device 10 moves ring distal end portion 25 along a surface shape of harvesting target fruit 93A to insert small fruit stem 95A of harvesting target fruit 93A inside each of harvest rings 21 and 22. Harvesting device 10 then harvests harvesting target fruit 93A by moving upper harvest ring 21 relative to lower harvest ring 22.

When ring distal end portion 25 is not moved along the surface shape of harvesting target fruit 93A and an operation of causing harvesting target fruit 93A to enter each of through holes 21A and 22A (upper through hole 21A and lower through hole 22A) is performed, each of harvest rings 21 and 22 may come into contact with an obstacle such as non-harvesting target fruit 93B or a leaf present around harvesting target fruit 93A. When each of harvest rings 21 and 22 comes into contact with an obstacle, the operation of causing harvesting target fruit 93A to enter each of through holes 21A and 22A cannot be smoothly performed, or the operation of causing harvesting target fruit 93A to enter each of through holes 21A and 22A needs to be performed again, so that harvest efficiency of fruit 93 decreases.

In harvesting device 10 according to the first embodiment, by moving ring distal end portion 25 along the surface shape of harvesting target fruit 93A, it is possible to reduce opportunities for harvest rings 21 and 22 to come into contact with an obstacle even when an obstacle such as non-harvesting target fruit 93B or a leaf is present around harvesting target fruit 93A. Therefore, it is possible to smoothly perform the operation of causing harvesting target fruit 93A to enter each of through holes 21A and 22A, and it is possible to prevent a decrease in harvest efficiency of fruit 93.

Next, the harvesting method will be described in detail. First, before the harvest operation is started, as shown in FIG. 6A, cam followers 332 are positioned at rear ends of lowering grooves 333A. In this state, for example, imaging unit 12 images tuft 91 from an end effector 1 side with respect to tuft 91, and transmits a captured image to control unit 13. Control unit 13 acquires the captured image and specifies harvesting target fruit 93A from among fruits 93 that are actually grown in tuft 91. Control unit 13 specifies, for example, ripe fruit 93 as harvesting target fruit 93A.

Next, control unit 13 controls work arm 11 to move end effector 1 such that harvesting target fruit 93A is positioned between ring distal end portion 25 and fruit stem 92 in the plan view (such that each of harvest rings 21 and 22 is positioned at a 0° position), as shown in FIG. 8. At this time, as shown in FIG. 9A, control unit 13 adjusts a posture of end effector 1 such that through holes 21A and 22A face upward, and moves end effector 1 such that ring distal end portion 25 closest to harvesting target fruit 93A is positioned at start point P1. At this time, opening surfaces of through holes 21A and 22A may be parallel to a horizontal plane or may not be parallel to the horizontal plane.

In this manner, the reason why the movement of ring distal end portion 25 along the surface shape of harvesting target fruit 93A is started from start point P1 instead of lowest point P2 is as follows. A case where an obstacle is present below harvesting target fruit 93A will be considered. In this case, when an attempt is made to start the movement of ring distal end portion 25 from lowest point P2, for example, when end effector 1 is moved in a horizontal direction to insert ring distal end portion 25 underneath harvesting target fruit 93A, ring distal end portion 25 may come into contact with the obstacle, and insertion of ring distal end portion 25 underneath harvesting target fruit 93A may fail. On the other hand, by starting the movement of ring distal end portion 25 from start point P1 and moving ring distal end portion 25 from start point P1 to lowest point P2 along the surface shape of harvesting target fruit 93A, ring distal end portion 25 can be inserted underneath harvesting target fruit 93A while pushing the obstacle downward by harvest rings 21 and 22. Therefore, it is possible to reduce the possibility that the insertion of ring distal end portion 25 underneath harvesting target fruit 93A fails.

Start point P1 is a point at which the driving of work arm 11 for moving end effector 1 to the vicinity of harvesting target fruit 93A is switched to the driving of end effector 1 alone. Start point P1 may be a position facing harvesting target fruit 93A and a position away from harvesting target fruit 93A. Start point P1 may be a position at which ring distal end portion 25 comes into contact with harvesting target fruit 93A. A position of start point P1 in a height direction is preferably a center of harvesting target fruit 93A in the height direction or a position lower than the center. For example, when a height of harvesting target fruit 93A in a vertical direction is H, the position of start point P1 in the height direction is preferably such that distance D1 from a lower end of harvesting target fruit 93A satisfies the following Formula (1).

0.25×H≤D1≤0.5 (1)

The reason why the position of start point P1 in the height direction is set to a position lower than the center of harvesting target fruit 93A in the height direction is as follows. For example, a case is considered in which harvesting target fruit 93A grows ripe such that inclination with respect to the vertical direction increases (an angle defined by the vertical direction and a line passing through the center of calyx 94 and the center of harvesting target fruit 93A increases). In this case, when the position of start point P1 in the height direction is set to a position higher than the center of harvesting target fruit 93A in the height direction, an amount by which harvesting target fruit 93A is pushed by ring distal end portion 25 moving downward increases when ring distal end portion 25 is moved toward lowest point P2. In this case, the position of harvesting target fruit 93A may be greatly displaced, and harvesting target fruit 93A may not be put into each of harvest rings 21 and 22. On the other hand, by setting the position of start point P1 in the height direction to a position lower than the center of harvesting target fruit 93A in the height direction, it is possible to reduce the amount by which harvesting target fruit 93A is pushed by ring distal end portion 25 moving downward when ring distal end portion 25 is moved toward lowest point P2. Therefore, it is possible to prevent the position of harvesting target fruit 93A from being largely displaced, and it is possible to put harvesting target fruit 93A into each of harvest rings 21 and 22.

As a method for determining the height position of start point P1, any one of the following two methods may be used. The first method is a method in which the height position of the lower end of harvesting target fruit 93A is calculated based on a captured image, and a position above the calculated height position of the lower end by a preset distance is determined as the height position of start point P1. In the second method, a height position and a height dimension of harvesting target fruit 93A are calculated based on a captured image. Next, distance D1 satisfying the above Formula (1) is calculated based on the calculated height dimension. Then, a position above the calculated height position of the lower end of harvesting target fruit 93A by distance D1 is determined as the height position of start point P1.

From the state shown in FIG. 9A, end effector 1 drives the advancing and retreating motor so that harvest mechanism support member 31 moves forward based on the control of control unit 13. When harvest mechanism support member 31 moves forward, cam followers 332 move downward along lowering grooves 333A while moving forward. As cam followers 332 move forward and downward, harvest mechanism 2 rotates so that ring distal end portion 25 moves downward while moving forward. As shown in FIG. 9B, when cam followers 332 reach a boundary position between lowering grooves 333A and lifting grooves 333B, harvest mechanism 2 is in a posture in which ring distal end portion 25 is positioned at a lowermost position. When harvest mechanism 2 is in the posture shown in FIG. 9B, ring distal end portion 25 is positioned at lowest point P2.

Lowest point P2 is a point positioned below harvesting target fruit 93A. A position of lowest point P2 in the height direction is preferably such that distance D2 from the lower end of harvesting target fruit 93A is 0 mm or more and 20 mm or less.

From the state shown in FIG. 9B, end effector 1 drives the advancing and retreating motor so that harvest mechanism support member 31 further moves forward based on the control of control unit 13. When harvest mechanism support member 31 further moves forward, cam followers 332 move upward along lifting grooves 333B while moving forward. As cam followers 332 move forward and upward, harvest mechanism 2 rotates so that ring distal end portion 25 moves upward while moving forward. With the rotation of harvest mechanism 2, harvesting target fruit 93A enters into each of through holes 21A and 22A. As shown in FIG. 9C, when cam followers 332 reach the front ends of lifting grooves 333B, harvest mechanism 2 is in a posture in which ring distal end portion 25 is positioned at an uppermost position. When harvest mechanism 2 is in the posture shown in FIG. 9C, ring distal end portion 25 is positioned at end point P3.

End point P3 is a point at which the operation of rotating harvest mechanism 2 while moving harvest mechanism 2 forward is switched to a harvest operation of harvesting target fruit 93A. End point P3 is preferably at a position higher than the upper end of harvesting target fruit 93A, and is not limited thereto when the position of small fruit stem 95 is higher than the upper end of harvesting target fruit 93A, particularly due to the way the fruit grows ripe. It is preferable that end point P3 is a position at which small fruit stem 95A of harvesting target fruit 93A is positioned inside each of through holes 21A and 22A, and ring distal end portion 25 is in contact with small fruit stem 95A. When ring distal end portion 25 comes into contact with small fruit stem 95 before cam followers 332 reach the front ends of lifting grooves 333B, control unit 13 may detect the contact and stop the driving of the advancing and retreating motor. With such a configuration, it is possible to prevent harvesting target fruit 93A from protruding upward from through holes 21A and 22A, making it not possible to harvest harvesting target fruit 93A. As a method for detecting the contact of ring distal end portion 25 with small fruit stem 95A, a method of detecting a torque of the advancing and retreating motor which varies depending on the presence or absence of the contact between ring distal end portion 25 and small fruit stem 95A can be exemplified.

Then, end effector 1 harvests harvesting target fruit 93A by moving upper harvest ring 21 relative to lower harvest ring 22 based on the control of control unit 13. For example, end effector 1 moves upper harvest ring 21 rearward without moving lower harvest ring 22. Upper harvest ring 21 moving rearward pulls harvesting target fruit 93A in a direction away from fruit stem 92 (rearward). At this time, although fruit stem 92 is also pulled rearward via small fruit stem 95A, fruit stem 92 and lower harvest ring 22 come into contact with each other, and a force pushing fruit stem 92 is generated in lower harvest ring 22 as a reaction to a pulling force of upper harvest ring 21. The pulling force acts between calyx 94 and fruit stem 92, and small fruit stem 95A is separated by release layer 96A. As a result of the separation, harvesting target fruit 93A falls and is harvested into a basket (not shown).

As shown in FIG. 8, even when each of harvest rings 21 and 22 is positioned at a position (+90° position) rotated counterclockwise (leftward) by 90° around small fruit stem 95A from the 0° position or at a position (−90° position) rotated clockwise (rightward) by 90° in the plan view, harvesting device 10 can prevent a decrease in the harvest efficiency of fruit 93 by moving ring distal end portion 25 along the surface shape of harvesting target fruit 93A.

For example, when each of harvest rings 21 and 22 is positioned at the +90° position, harvesting device 10 can cause harvesting target fruit 93A to enter each of through holes 21A and 22A while reducing opportunities for each of harvest rings 21 and 22 to come into contact with an obstacle G such as a leaf positioned near each of harvest rings 21 and 22 by moving ring distal end portion 25 along the surface shape of harvesting target fruit 93A. When each of harvest rings 21 and 22 is positioned at the −90° position, harvesting device 10 can cause harvesting target fruit 93A to enter each of through holes 21A and 22A while reducing opportunities for harvest rings 21 and 22 to come into contact with non-harvesting target fruit 93B positioned near each of harvest rings 21 and 22 by moving ring distal end portion 25 along the surface shape of harvesting target fruit 93A. When each of harvest rings 21 and 22 is positioned at the +90° position or the −90° position, harvesting device 10 moves upper harvest ring 21 rearward without moving lower harvest ring 22, thereby applying a pulling force for separating calyx 94 and fruit stem 92 from each other to harvest harvesting target fruit 93A.

As described above, even when end effector 1 is positioned in the range from the 0° position to the +90° position or in the range from the 0° position to the −90° position, harvesting device 10 can harvest fruit 93 without decreasing the harvest efficiency by moving ring distal end portion 25 along the surface shape of harvesting target fruit 93A.

### Second Embodiment

Next, a second embodiment of the present disclosure will be described.

<Configuration of Harvesting Device>

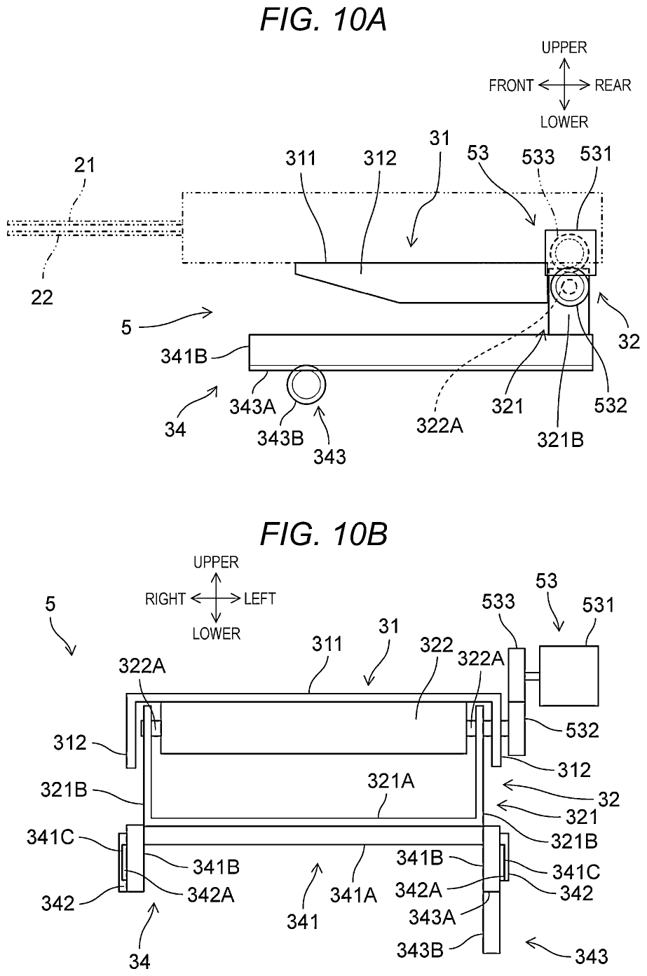

First, a configuration of a harvesting device will be described. FIG. 10A is a schematic side view of a harvest control mechanism constituting an end effector of the harvesting device. FIG. 10B is a schematic front view of the harvest control mechanism. A description of the same configuration as that of harvesting device 10 in the first embodiment will be simplified or omitted.

As shown in FIG. 2, harvesting device 10A in the second embodiment differs from harvesting device 10 in the first embodiment in that harvesting device 10A includes end effector 4 and control unit 13A instead of end effector 1 and control unit 13. End effector 4 includes harvest mechanism 2 and harvest control mechanism 5.

As shown in FIGS. 10A and 10B, harvest control mechanism 5 includes harvest mechanism support member 31, rotation support portion 32, and rotation control mechanism 53. Rotation control mechanism 53 controls a rotation state of harvest mechanism support member 31. Rotation control mechanism 53 includes rotation motor 531 and driven pinion 532. Rotation motor 531 is driven under control of control unit 13. Driven pinion 532 is fixed to left-side rotary shaft portion 322A fixed to coupling member 322. Driven pinion 532 is fixed so as to mesh with drive pinion 533 fixed to a rotary shaft of rotation motor 531. A power transmission unit that includes a gear, a worm gear, or the like and transmits a driving force of rotation motor 531 to driven pinion 532 may be disposed between driven pinion 532 and drive pinion 533.

<Operation of Harvesting Device>

Next, as an operation of harvesting device 10A, a harvesting method for harvesting target fruit 93A will be described. The description of the same operation as that of the harvesting method in the first embodiment will be simplified or omitted.

Similarly to harvesting device 10 according to the first embodiment, as shown in FIG. 7, harvesting device 10A moves upper harvest ring 21 and lower harvest ring 22 such that ring distal end portion 25 of end effector 4 draws trajectory L including start point P1, lowest point P2, and end point P3, and small fruit stem 95A of harvesting target fruit 93A is inserted into each of harvest rings 21 and 22. At this time, control unit 13A of harvesting device 10A adjusts rotation angles of the advancing and retreating motor and rotation motor 531 to move upper harvest ring 21 and lower harvest ring 22 such that ring distal end portion 25 draws trajectory L.

For example, control unit 13A acquires a captured image of tuft 91 from imaging unit 12. Control unit 13A specifies, based on the captured image, harvesting target fruit 93A and calculates a surface shape of harvesting target fruit 93A. As described above, the surface shape of harvesting target fruit 93A means an outline (outer shape) of harvesting target fruit 93A when harvesting target fruit 93A is viewed from, for example, the right side. For example, when imaging unit 12 images tuft 91 from an end effector 1 side with respect to tuft 91, the outline of harvesting target fruit 93A when viewed from the right side is not shown in the captured image. However, a shape of fruit 93 as viewed from the right side and a shape of fruit 93 as viewed from the end effector 1 side are substantially the same. Therefore, control unit 13A regards the outline of harvesting target fruit 93A viewed from the end effector 1 side in the captured image as the outline of harvesting target fruit 93A viewed from the right side, and can calculate the outline as the surface shape of fruit 93 along which ring distal end portion 25 moves.

Thereafter, control unit 13A determines trajectory L including start point P1, lowest point P2, and end point P3 based on the calculated surface shape, and controls the advancing and retreating motor and rotation motor 531 such that ring distal end portion 25 draws trajectory L. Harvesting device 10A then harvests harvesting target fruit 93A by moving upper harvest ring 21 relative to lower harvest ring 22.

Similarly to harvesting device 10 in the first embodiment, harvesting device 10A in the second embodiment moves ring distal end portion 25 along the surface shape of harvesting target fruit 93A. Therefore, even when end effector 1 is positioned in the range from the 0° position to the +90° position or in the range from the 0° position to the −90° position, it is possible to reduce opportunities for harvest rings 21 and 22 to come into contact with an obstacle such as non-harvesting target fruit 93B or a leaf present around harvesting target fruit 93A, and it is possible to prevent a decrease in harvest efficiency of fruit 93. Since the posture of harvest mechanism 2 can be changed by adjusting a rotation angle of rotation motor 531, upper harvest ring 21 and lower harvest ring 22 can be moved so as to draw appropriate traj ectory L according to surface shapes of harvesting target fruits 93A having various shapes or sizes. Therefore, harvesting device 10A can prevent the decrease in the harvest efficiency of fruit 93 regardless of the shape or the size of harvesting target fruit 93A.

### Modifications of Embodiments

It is needless to say that the present disclosure is not limited to the embodiments described above, and various modifications can be made without departing from the gist of the present disclosure. The above embodiments and the modifications described below may be combined in any manner as long as they function normally.

For example, harvesting devices 10 and 10A may separate harvesting target fruit 93A from fruit stem 92 by moving upper harvest ring 21 relative to lower harvest ring 22 in a state where harvesting target fruit 93A is positioned in each of through holes 21A and 22A.

Harvesting devices 10 and 10A start the movement of ring distal end portion 25 along the surface shape of harvesting target fruit 93A from start point P1, and may start the movement from lowest point P2.

As the harvesting device according to the present disclosure, a configuration in which harvest mechanism 2 is rotated when ring distal end portion 25 is moved along the surface shape of harvesting target fruit 93A is exemplified, and a configuration in which harvest mechanism 2 is not rotated may be applied. For example, a mechanism for moving harvest mechanism 2 in the front-rear direction (for example, advancing and retreating movement control mechanism 34) and a mechanism for moving harvest mechanism 2 in an upper-lower direction may be separately provided in the harvest control mechanism. The harvest control mechanism may be provided with a mechanism for moving harvest mechanism 2 in the front-rear direction, and harvest mechanism 2 may be moved in the upper-lower direction by driving work arm 11. The harvest control mechanism may be provided with a mechanism for moving harvest mechanism 2 in the upper-lower direction, and harvest mechanism 2 may be moved in the front-rear direction by driving work arm 11. Alternatively, ring distal end portion 25 may be moved along the surface shape of harvesting target fruit 93A by driving only work arm 11.

When end effector 1 separates harvesting target fruit 93A from fruit stem 92, lower harvest ring 22 may be moved rearward without moving upper harvest ring 21, or one of upper harvest ring 21 and lower harvest ring 22 may be moved forward and the other harvest ring may be moved rearward.

According to the harvesting method of the present disclosure, it is possible to prevent a decrease in harvest efficiency of fruits.

The present disclosure can be applied to a harvesting method.

What is claimed is:

1. A harvesting method performed by a harvesting device, the harvesting device including:
an upper harvest ring having an upper through hole through which a fruit can be passed, and
a lower harvest ring disposed below the upper harvest ring and having a lower through hole through which the fruit can be passed, wherein the harvest method comprising:
by the harvesting device,
moving the upper harvest ring and the lower harvest ring along a surface shape of the fruit to position a fruit stalk of the fruit or the fruit inside each of the upper through hole and the lower through hole; and
moving the upper harvest ring relative to the lower harvest ring to harvest the fruit.

2. The harvesting method according to claim 1, wherein the moving of the upper harvest ring and the lowest harvest ring along the surface shape of the fruit includes:
moving the upper harvest ring and the lower harvest ring such that a distal end portion closest to the fruit in the upper harvest ring and the lower harvest ring in a posture in which the upper through hole and the lower through hole face upward reaches, from a start point facing the fruit to an end point opposite to the start point with respect to the fruit through a lowest point lower than a lower end of the fruit.

3. The harvesting method according to claim 2, wherein the start point is a center of the fruit in a height direction or a position lower than the center.

4. The harvesting method according to claim 2, wherein the end point is a position higher than an upper end of the fruit.

5. The harvesting method according to claim 2, wherein the moving of the upper harvest ring and the lowest harvest ring along the surface shape of the fruit further includes:
stopping, movement of the upper harvest ring and the lower harvest ring when the harvesting device detects that the upper harvest ring comes into contact with the fruit stalk after the upper harvest ring and the lower harvest ring pass through the lowest point.

6. The harvesting method according to claim 1, wherein the moving of the upper harvest ring and the lowest harvest ring along the surface shape of the fruit includes:
calculating the surface shape of the fruit based on a captured image of the fruit, and
moving the upper harvest ring and the lower harvest ring along the calculated surface shape.

7. The harvesting method according to claim 1, wherein the fruit is a tomato.

8. The harvesting method according to claim 1, wherein the moving of the upper harvest ring and the lowest harvest ring along the surface shape of the fruit includes:
moving the upper harvest ring and the lower harvest ring to reciprocate up and down along an upper-lower direction while moving the upper harvest ring and the lower harvest ring in one direction along a front-rear direction, thereby moving a distal end portion of each of the upper harvest ring and the lower harvest ring along a trajectory including a start point, a lowest point positioned before the start point and lower than the start point, and an end point positioned before the lowest point and higher than the start point.
